(19) United States
(12) Patent Application Publication
(10) Pub. No.: US 2022/0104229 A1
(43) Pub. Date: Mar. 31, 2022

(54) LINK LATENCY DETERMINATION

(71) Applicant: QUALCOMM Incorporated, San Diego, CA (US)

(72) Inventors: Leena Zacharias, San Jose, CA (US); Arnaud Meylan, San Diego, CA (US); Shyamal Ramachandran, San Diego, CA (US)

(21) Appl. No.: 17/039,952

(22) Filed: Sep. 30, 2020

(51) Int. Cl. H04W 72/12; H04W 24/04; H04W 24/02; H04L 1/18; H04L 12/26

(52) U.S. Cl. CPC H04W 72/1273; H04W 72/1289; H04L 43/0852; H04W 24/02; H04L 1/1812; H04W 24/04

(57) ABSTRACT

A wireless communication device is described. The wireless communication device includes a modem. The modem is configured to determine a link latency. The modem is configured to determine the link latency based on a network configuration. The modem is also configured to send the link latency. The modem is configured to send the link latency to a processor.

### FIELD OF DISCLOSURE

The present disclosure relates generally to electronic devices. More specifically, the present disclosure relates to link latency determination.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently, or with higher quality are often sought after.

Some electronic devices (e.g., cellular phones, smartphones, laptop computers, etc.) communicate with other electronic devices. For example, electronic devices may transmit and/or receive radio frequency (RF) signals to communicate. Improving electronic device communication may be beneficial.

### SUMMARY

A wireless communication device is described. The wireless communication device includes a modem. The modem is configured to determine a link latency based on a network configuration. The modem is also configured to send the link latency to a processor.

The modem may be configured to determine the link latency based on an inter modem-processor delay value. The modem may be configured to determine the link latency based on a time-division duplexing (TDD) delay value in a case that TDD is configured. The modem may be configured to calculate the TDD delay value as an average of slot delay values based on a TDD slot configuration.

The modem may be configured to determine the link latency based on a hybrid automatic repeat request (HARQ) delay value. The modem may be configured to determine the link latency based on a number of HARQ retransmissions or a HARQ failure probability.

The modem may be configured to determine the link latency based on a data transmission delay value. The modem may be configured to determine the data transmission delay value based on downlink control information (DCI).

The modem may be configured to determine the link latency based on a data processing delay value that is based on a numerology. The modem may be configured to determine the link latency based on a data processing delay value that is based on a capability type.

The modem may be configured to determine the link latency based on a wake-up time value. The modem may be configured to determine the wake-up time value based on a discontinuous reception (DRX) cycle, whether a low latency mode (LLM) is enabled, or a synchronization signal block (SSB) monitoring occasion.

The modem may be configured to determine the link latency based on a scheduling request (SR) delay value. The modem may be configured to determine the SR delay value based on a SR periodicity. The modem may be configured to determine the link latency based on a scheduling request (SR) failure delay value.

The modem may be configured to determine the link latency based on a network scheduling delay value. The modem may be configured to determine the network scheduling delay value based on a numerology and a capability type.

The link latency may be an uplink link latency. The link latency may be a downlink link latency.

The modem may be configured to determine the link latency based on a downlink control-to-data delay value. The modem may be configured to determine the downlink control-to-data delay value based on a numerology, a capability type, and a duplexing type. The modem may be configured to determine the downlink control-to-data delay value based on downlink control information (DCI).

The processor may be configured to determine whether to switch to another link based on the link latency, may be configured to determine whether to switch to a low latency mode (LLM) based on the link latency, or may be configured to adjust a dejitter buffer based on the link latency.

The modem may be configured to determine the link latency and send the link latency in a connected mode per radio resource control (RRC) configuration. The modem may be configured to determine the link latency and send the link latency for a master cell group (MCG) and may be configured to determine a second link latency and send the second link latency for a secondary cell group (SCG).

The modem may be configured to determine the link latency and send the link latency for a split bearer. The modem may be configured to determine the link latency and send the link latency for a first numerology and may be configured to determine a second link latency and send the second link latency for a second numerology.

A method performed by a wireless communication device is also described. The method includes determining, by a modem, a link latency based on a network configuration. The method also includes sending, by the modem, the link latency to a processor.

A non-transitory tangible computer-readable medium storing computer-executable code is also described. The computer-readable medium includes code for causing a modem to determine a link latency based on a network configuration. The computer-readable medium also includes code for causing the modem to send the link latency to a processor.

An apparatus is also described. The apparatus includes means for determining a link latency on a modem based on a network configuration. The apparatus also includes means for sending the link latency to a processor.

### BRIEF DESCRIPTION OF THE DRAWINGS

FIG. 1 is a block diagram illustrating one example of a wireless communication device in which systems and methods for link latency determination may be implemented;

FIG. 2 is a flow diagram illustrating an example of a method for link latency determination;

FIG. 3 is a diagram illustrating an example of a smartphone in which examples of techniques for determining a link latency may be implemented;

FIG. 4 is a diagram illustrating examples of delays and/or times that may occur in uplink link latency;

FIG. 5 is a flow diagram illustrating an example of a method for determining an uplink link latency;

FIG. 6 is a diagram illustrating examples of delays and/or times that may occur in downlink link latency;

FIG. 7 is a flow diagram illustrating an example of a method for determining a downlink link latency;

FIG. 8 is a flow diagram illustrating an example of a method for determining an uplink link latency and a downlink link latency; and

FIG. 9 illustrates certain components that may be included within an electronic device configured to implement various examples of the systems and methods disclosed herein for link latency determination.

### DETAILED DESCRIPTION

Some examples of the systems and methods disclosed herein relate to link latency determination for wireless communication devices. Wireless communication devices may communicate with other devices using radio frequency (RF) signals. Link latency is a period (e.g., time, delay, etc.) for a wireless communication device to communicate traffic (e.g., payload data) with a radio access network (RAN) (e.g., base station, access point, evolved Node B (eNB), new radio (NR) Node B (gNB), etc.). A wireless communication device may determine (e.g., estimate) link latency. For example, a wireless communication device may estimate NR RAN round-trip link latency for a default bearer for sparse traffic. Some examples of link latency include uplink (UL) link latency and downlink (DL) link latency. Uplink link latency may be a link latency for a wireless communication device to send payload data to a RAN. Downlink link latency may be a link latency for a wireless communication device to receive payload data from a RAN. In some examples, a modem of a wireless communication device may determine (e.g., estimate) the uplink link latency and/or downlink link latency.

The uplink link latency and/or the downlink link latency may be provided or reported to a processor (e.g., application processor, application(s) running on the processor, client(s) on the processor, etc.). For instance, the uplink link latency and the downlink link latency are provided to a processor in separate reports. In some examples, the link latency estimation provides a way for applications to get link latency without using ping information. For instance, a wireless communication device may need to set up a radio resource control (RRC) connection, generate additional traffic, and/or receive a response from a far-end device (e.g., server) to determine ping information. In some examples of the techniques described herein, link latency may be determined without ping information. For instance, a wireless communication device may not need to set up an RRC connection, not need to generate additional traffic (e.g., a ping packet), and/or not need to receive a response from a far-end device (e.g., a device beyond the RAN, a server, etc.) to determine link latency. In some examples, the link latency may be determined (e.g., estimated) based on one or more parameters. Some examples of the techniques described herein may help to provide reduced latency. For instance, some examples of the techniques may indicate when latency is high and/or may enable switching to a lower latency mode to satisfy application demands.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

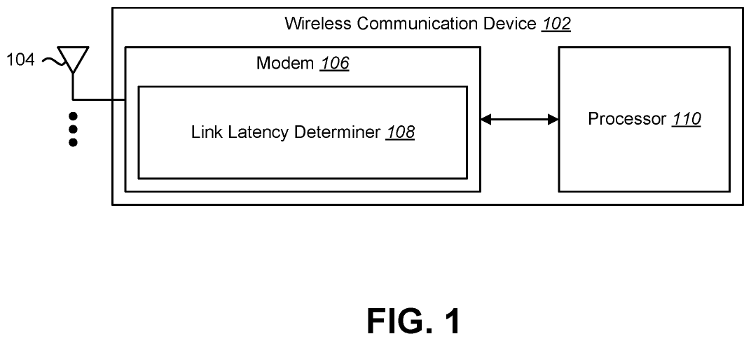

FIG. 1 is a block diagram illustrating one example of a wireless communication device 102 in which systems and methods for link latency determination may be implemented. The wireless communication device 102 is a device or apparatus for transmitting and/or receiving RF signals. Examples of the wireless communication device 102 include user equipments (UEs), smartphones, tablet devices, computing devices, computers (e.g., desktop computers, laptop computers, etc.), televisions, cameras, virtual reality devices (e.g., headsets), vehicles (e.g., semi-autonomous vehicles, autonomous vehicles, etc.), robots, aircraft, drones, unmanned aerial vehicles (UAVs), healthcare equipment, gaming consoles, Internet of Things (IoT) devices, etc. The wireless communication device 102 includes one or more components or elements. One or more of the components or elements may be implemented in hardware (e.g., circuitry) or a combination of hardware and instructions (e.g., a processor with software and/or firmware stored in memory).

In some examples, the wireless communication device 102 includes one or more antennas 104, a modem 106 and/or a processor 110. In some examples, the wireless communication device 102 includes one or more other components and/or elements. For example, the wireless communication device 102 may include an RF front end (RFE), switch(es), filter(s), power amplifier(s), downcoverter(s), upconverter(s), memory, and/or display (e.g., touchscreen), etc.

The modem 106 performs one or more operations on received signals from the antenna(s) 104. In some examples, the modem 106 may be coupled to one or more antennas 104 for receiving signals. The modem 106 may be circuitry configured to perform one or more functions. For example, the modem 106 may include one or more integrated circuits with circuit components (e.g., transistors, resistors, capacitors, etc.). For instance, the modem 106 includes one or more modem processors for performing operations (e.g., demodulation, decoding, etc.). In some examples, the modem 106 may be included in a receiver and/or transmitter (e.g., transceiver).

The antenna(s) 104 may capture one or more signals (e.g., electromagnetic signals, RF signals, wireless signals, etc.) and provide the signal(s) to the modem 106. The modem 106 may convert the signal(s) or portions of the signal(s) into data (e.g., bits). For example, the modem 106 performs demodulation, detection, and/or decoding, etc. In some examples, the modem 106 executes instructions to perform the one or more functions. In some examples, the modem 106 includes one or more functionalities that are structurally implemented as hardware (e.g., circuitry). In some examples, the modem 106 includes a baseband processor, a modem processor, and/or any combination thereof. In some examples, the wireless communication device 102 and/or the modem 106 may be configured to perform one or more of the methods 200, 500, 700, 800 and/or one or more portions of method(s), function(s), and/or operation(s) described in relation to one or more of the Figures. In some examples, the wireless communication device 102 and/or modem 106 includes one or more of the components and/or elements described in relation to one or more of the Figures.

In some examples, the wireless communication device 102 and/or modem 106 may implement one or more aspects of one or more specifications (e.g., 3rd Generation Partnership Project (3GPP) Release 15, 3GPP Release 16, fifth generation (5G), New Radio (NR), and/or Long-Term Evolution (LTE), etc.). In some examples, the wireless communication device 102 transmits signals to one or more base stations and/or receives signals from one or more base stations. For instance, the wireless communication device 102 may transmit signals to and/or may receive signals from one or more RANs, eNBs, gNBs, cellular networks, etc. In some examples, the wireless communication device 102 also communicates with one or more other radio access technologies (RATs) (e.g., wireless local area network (WLAN), Wi-Fi network, personal area network (PAN), and/or Bluetooth, etc.).

The modem 106 is configured to determine a link latency. For example, the modem 106 includes a link latency determiner 108 that determines an uplink link latency and/or a downlink link latency. An uplink link latency may be a period and/or delay (e.g., amount of time) for the wireless communication device 102 to transmit payload data to a RAN. A downlink link latency may be a period and/or delay (e.g., amount of time) for the wireless communication device 102 to receive payload data from a RAN. The link latency determiner 108 may be implemented in hardware (e.g., circuitry) or in a combination of hardware and instructions (e.g., a processor with instructions stored in modem 106 memory). In some examples, the wireless communication device 102 (e.g., modem 106) may include memory. The memory may store one or more values, factors, look-up tables, databases, numbers, data structures, etc. In some configurations, one or more of the values, factors, look-up tables, databases, numbers, data structures, etc., described herein may be stored in memory and/or accessed (by the modem 106, for instance).

In some examples, the modem 106 and/or link latency determiner 108 determine link latency based on one or more values and/or factors. In some approaches, the modem 106 may be configured to determine a link latency based on a network configuration. For instance, a network configuration (e.g., RRC configuration) may indicate one or more of the value(s) and/or factor(s) (e.g., may be utilized to determine one or more of the value(s) and/or factor(s)) that may be utilized to determine the link latency. For instance, to determine (e.g., estimate) a link latency, the modem 106 and/or link latency determiner 108 may combine (e.g., sum) values and/or factors (e.g., numbers, numerical values, etc.) that represent times and/or delays that occur in transmitting payload data to a RAN and/or in receiving payload data from a RAN. Examples of values and/or factors include an inter modem-processor delay value, wake-up time value (e.g., rude wake-up time), scheduling request (SR) delay value, network scheduling delay value, time-division duplexing (TDD) delay value, downlink control-to-data delay value, data transmission delay value, data processing delay value, hybrid automatic repeat request (HARQ) delay value, and SR failure delay value. In some examples, one or more values and/or factors are expressed in units of symbols, slots, and/or time (e.g., seconds (s), milliseconds (ms), microseconds (μs), etc.). One or more values and/or factors may be converted to time using a numerology of an uplink and/or downlink (UL/DL) bandwidth part (BWP). In some examples, the wireless communication device 102 (e.g., modem 106 and/or link latency determiner 108) may obtain (e.g., read from memory, determine, calculate, and/or measure, etc.) one or more of the values and/or factors. The values and/or factors will be described in greater detail below.

The modem 106 and/or link latency determiner 108 may determine a link latency (e.g., an uplink link latency and/or a downlink link latency) based on one or more of the factors and/or values. In some examples, one or more of the factors and/or values may be excluded from the determination (e.g., not included in the determination) and/or not utilized in the determination. In some examples, different combinations of values and/or factors may be utilized for uplink link latency determination relative to downlink link latency determination. Different combinations of values and/or factors may be utilized in different examples of link latency determination. In some examples, different approaches may be utilized to determine one or more of the values and/or factors for uplink link latency determination relative to downlink link latency determination. In some examples, one or more additional and/or different factors and/or values may be utilized to determine link latency.

Table (1) provides examples of values and/or factors that may be utilized to determine (e.g., that may contribute to) uplink link latency and/or downlink link latency in some approaches. For example, Table (1) indicates whether values and/or factors may be utilized in an uplink link latency determination and/or a downlink link latency determination in some approaches.

TABLE (1)

| | Uplink Link | Downlink Link |
|---|---|---|
| Value and/or Factor | Latency | Latency |
| Inter Modem-Processor Delay Value | Yes | Yes |
| Wake-Up Time Value | Yes | No |
| SR Delay Value | Yes | No |
| Network Scheduling Delay Value | Yes | Yes |
| TDD Delay Value | Yes | Yes |
| Downlink Control-to-Data Delay Value | Yes | Yes |
| Data Transmission Delay Value | Yes | Yes |
| Data Processing Delay Value | Yes | Yes |
| HARQ Delay Value | Yes | Yes |
| SR Failure Delay Value | Yes | No |

In some examples, the modem 106 (e.g., link latency determiner 108) is configured to determine the link latency (e.g., uplink link latency and/or downlink link latency) based on an inter modem-processor delay value. The inter modem-processor delay value may be an amount of time for a packet to be sent between the modem 106 and the processor 110 (e.g., an amount of time to transmit a packet across an internal interface or bus between the modem 106 and the processor 110). In some examples, the inter modem-processor delay value is a static value (e.g., 1 ms) or a static value with an additional waiting delay. The waiting delay may be a delay that occurs if a packet waits before transfer (e.g., before being sent) from the processor 110 to the modem 106 or from the modem 106 to the processor 110. For instance, a packet may wait before transfer if an internal bus or interface between the modem 106 and processor 110 cannot immediately transfer the packet. In some examples, a waiting delay case may be detected and/or the inter modem-processor delay value may be adjusted based on the waiting delay.

For uplink link latency determination, for instance, the inter modem-processor delay value may be 1 ms (in a case of immediate transfer, for example) or may be 1 ms plus a waiting delay. In uplink, the packet may be sent from the processor 110 to the modem 106. In some examples, the modem 106 may determine the waiting delay. For instance, the modem 106 may determine that a packet had a waiting delay (e.g., 0.1 ms, 0.2 ms, 0.5 ms, 0.8 ms, 1 ms, 2 ms, 6 ms, etc., due to bus and/or interface loading) and may add the waiting delay to the static value to determine the inter modem-processor delay value.

For downlink link latency determination, for instance, the inter modem-processor delay value may be 1 ms (in a case of immediate transfer upon arrival, for example) or may be 1 ms plus a waiting delay. In downlink, the packet may be sent from the modem 106 to the processor 110. In some examples, the first packet goes through without any waiting or accumulation delay (e.g., may be sent to the processor 110 directly upon arrival). In some examples, the modem 106 may determine the waiting delay. For instance, the modem 106 may determine that a packet had a waiting delay (e.g., 0.1 ms, 0.2 ms, 0.5 ms, 0.8 ms, 1 ms, 2 ms, 6 ms, etc., due to bus and/or interface loading) and may add the waiting delay to the static value to determine the inter modem-processor delay value.

In some examples, the modem 106 (e.g., link latency determiner 108) is configured to determine the link latency (e.g., uplink link latency) based on a wake-up time value. The wake-up time value may be an amount of time for the modem 106 to transition out of a sleep state. For instance, the wake-up time value is an amount of time to wake up the modem 106 from a sleep state when an uplink packet arrives at the modem 106.

In some examples, the modem 106 (e.g., link latency determiner 108) determines the wake-up time value (e.g., rude wake-up time) based on a discontinuous reception (DRX) (e.g., connected mode DRX (CDRX)) cycle and/or based on whether a low latency mode (LLM) is enabled (e.g., an LLM configuration). For instance, the modem 106 selects a sleep state (e.g., light sleep or deep sleep) based on an amount of sleep duration available. If the sleep duration is more than a threshold (e.g., 10 ms) and/or an LLM condition is satisfied (e.g., LLM that allows deep sleep), for instance, then the wireless communication device 102 (e.g., user equipment (UE)) may select deep sleep and/or a wake-up time value for deep sleep (e.g., a value in 6-14 ms). The modem 106 may select light sleep and/or a wake-up time value for light sleep (e.g., a value in 2-6 ms) when the sleep duration (e.g., DRX long cycle) is less than or equal to a threshold (e.g., 10 ms) and/or when another LLM condition is satisfied (e.g., LLM that only allows light sleep). Otherwise, deep sleep may be possible and worst-case rude wake-up latency may be included. A wake-up time value of 0 may be used when DRX is not configured.

In some examples, the modem 106 (e.g., link latency determiner 108) determines the wake-up time value based on one or more synchronization signal block (SSB) monitoring occasions. For instance, the sleep state may depend (e.g., may also depend) on one or more SSB monitoring occasions. The modem 106 may keep track of a sleep state (for each instance of sleep, for example), and may weight wake-up time values based on the tracked sleep state. For example, if an SSB monitoring occasion occurs during a CDRX Off state, the modem 106 may wake up at that time and select a light sleep state instead of a deep sleep state. In one or more CDRX Off states, the modem 106 may keep track of what kind of sleep state was used and may weight the wake-up time values based on the probability(ies) of being in each sleep state. Accounting for the effect of SSB monitoring occasion(s) on sleep state may provide a wake-up time value with increased accuracy (relative to just using DRX cycle and LLM aspects, for instance). The modem 106 (e.g., link latency determiner 108) may determine the wake-up time value based on a DRX cycle, whether an LLM is enabled, and/or an SSB monitoring occasion.

In some examples, the modem 106 (e.g., link latency determiner 108) determines the link latency based on an SR delay value. An SR delay value may be an average wait time for an SR occasion based on an SR configuration (including the transmission time for SR, for example). In some examples, the SR configuration is an SR configuration of a default Internet bearer. If there are multiple SR configurations, then the SR used by the logical channel mapped to the default bearer may be used. In some examples, the SR configuration corresponds to a physical uplink control channel (PUCCH) configuration in an active BWP.

In some examples, the modem 106 (e.g., link latency determiner 108) determines the SR delay value based on an SR periodicity. For instance, in a case that the SR takes a number of symbols (e.g., one or more symbols) to transmit, the SR delay value in symbols may be a sum of the number and SR periodicity and/or an average thereof. In some examples, the SR periodicity is converted to symbols from slots based on a numerology (except for two values “sym2” (2 symbols) and “sym6or 7” (7 symbols), for instance).

In some examples, the modem 106 (e.g., link latency determiner 108) determines the link latency based on a network scheduling delay value. The network scheduling delay value may indicate a delay for the network (e.g., RAN, base station, eNB, gNB, etc.) to schedule downlink control information (DCI) after receiving an SR in the uplink or receiving data from a core network in downlink. In uplink, for example, the network scheduling delay value may include a decoding time of a PUCCH containing an SR and a scheduling delay quantity. In some approaches, the scheduling delay quantity may be a value (e.g., between 1-3 ms).

In some examples, the modem 106 (e.g., link latency determiner 108) determines the network scheduling delay value based on a numerology and a capability type. The modem 106 (e.g., link latency determiner 108) may look up the PDSCH processing time based on the numerology and capability type. For instance, the modem 106 may determine the network scheduling delay in a PDSCH processing time table, where PDSCH processing times may be in a range between 10 ms and 25 ms for a first capability type and/or between 2 and 10 ms for a second capability type depending on numerology. A scheduling delay quantity may be added to the PDSCH processing time to determine the network scheduling delay value. In some approaches, capability 2 may be applicable if (e.g., only if) the wireless communication device 102 (e.g., UE) supports capability 2 and capability 2 is configured by the network (e.g., RAN).

For downlink link latency determination, the network scheduling delay value may include downlink layer 2 (L2) processing time at the network (e.g., RAN) and scheduling delay due to loading. In some examples, the modem 106 assigns a fixed value (since the wireless communication device 102 may not measure the L2 processing time and scheduling delay in some examples). For instance, the modem 106 assigns a fixed value (e.g., 4 ms) for downlink network scheduling delay (e.g., downlink network scheduling delay=4 ms).

In some cases (for a ping packet, for instance), core network delay may be such that an echo (e.g., ping response) comes while the wireless communication device 102 is still in DRX active time (due to an inactivity timer, for example). Accordingly, the network scheduling delay may not account for CDRX delay in some approaches.

In some examples, the modem 106 (e.g., link latency determiner 108) determines the link latency based on a downlink control-to-data delay value. The downlink control-to-data delay value may be an amount of time from downlink control information (DCI) (e.g., from issuance of DCI) to beginning of data (e.g., to the beginning of data transmission), including the transmission time of DCI.

In some examples, the modem 106 (e.g., link latency determiner 108) determines the downlink control-to-data delay value based on a numerology, a capability type, and a duplexing type. For instance, the modem 106 (e.g., link latency determiner 108) may determine that when frequency-division duplexing (FDD) is configured, the downlink control-to-data delay value for uplink link latency may be a DCI duration (e.g., 3 symbols) plus a physical uplink shared channel (PUSCH) preparation time. In some approaches, the modem 106 (e.g., link latency determiner 108) may look up the PUSCH preparation time (e.g., N2 from modem 106 memory, from a look-up table, etc.). For instance, the modem 106 (e.g., link latency determiner 108) looks up the PUSCH preparation time based on the configured numerology and capability type in accordance with Table (2). In some approaches, capability 2 may be applicable if (e.g., only if) the wireless communication device 102 (e.g., UE) supports capability 2 and capability 2 is configured by the network (e.g., RAN). In the following table, FR1 denotes frequency range 1, which may include sub-6 gigahertz (GHz) frequencies (in NR, for example).

TABLE (2)

| | PUSCH Preparation | PUSCH Preparation |
|---|---|---|
| | Time (N2) | Time (N2) in |
| Numerology, μ | in Symbols for | Symbols for |
| (Subcarrier Spacing) | Capability 1 | Capability 2 |

| | | | |
|---|---|---|---|
| 0 | (15 kHz) | 10 | 5 |
| 1 | (30 kHz) | 12 | 5.5 |
| 2 | (60 kHz) | 23 | 11 (for FR1, |
| | | | for example) |
| 3 | (120 kHz) | 36 | N/A |

The modem 106 (e.g., link latency determiner 108) may determine that when TDD is configured, the downlink control-to-data delay value for uplink link latency may be 0. In a case of TDD, for example, a delay due to TDD may be determined as the TDD delay value.

In some examples, the downlink control-to-data delay value for downlink link latency is a DCI duration (e.g., 3 symbols), with N0=0 as a nominal delay until PDSCH. For downlink link latency, the downlink control-to-data delay value may be similarly determined regardless of duplexing type (e.g., FDD or TDD).

In some examples, the modem 106 (e.g., link latency determiner 108) determines the downlink control-to-data delay value based on DCI. The modem 106 (e.g., link latency determiner 108) determines the downlink control-to-data delay value as a DCI duration from network (e.g., RAN) allocation plus a K0 or K2 value from DCI. For instance, the K2 value from DCI may be utilized for uplink link latency determination, and/or the K0 value from DCI may be utilized for downlink link latency determination. K2 may be a PUSCH preparation time indicated by the DCI and/or K0 may be delayed until a PDSCH indicated by the DCI. These examples may utilize K0 and K2 values instead of utilizing N0 and N2 values. Utilizing the DCI (e.g., K0 and/or K2) may provide increased accuracy in link latency determination (relative to utilizing N0 and N2 values, for example).

In some examples, the modem 106 (e.g., link latency determiner 108) determines link latency based on a TDD delay value in a case that TDD is configured. For example, the modem 106 (e.g., link latency determiner 108) may utilize the TDD slot configuration of a cell (e.g., primary cell (PCell)) to determine a TDD delay value. One or more TDD delays may be determined according to a numerology of a BWP after converting from a reference subcarrier spacing (SCS) if the BWP and SCS are different. In some examples, the TDD delay value may be applicable if TDD is configured. Otherwise (e.g., for FDD), the TDD delay value may be set to 0 or may not be utilized in the link latency determination. Common and/or dedicated RRC configurations may be utilized to determine the TDD configuration.

In some examples, the modem 106 (e.g., link latency determiner 108) determines slot delay values for each slot of a TDD slot configuration. For instance, the modem 106 (e.g., link latency determiner 108) may determine (e.g., count) a wait time (e.g., a number of slots) until a communication (e.g., PUSCH or PUCCH for uplink, PDSCH for downlink) can begin relative to each slot. In some examples, the modem 106 may average the slot delay values for a TDD frame to determine the TDD delay value.

For uplink link latency, the TDD delay value may be an average waiting time for PDCCH and PUSCH due to a TDD slot configuration. For downlink link latency, the TDD delay value may be an average waiting time for PDCCH and PDSCH due to a TDD slot configuration.

The TDD delay value for PUCCH may be an average waiting time for sending PUCCH feedback due to a TDD slot configuration. For uplink link latency determination, the modem 106 (e.g., link latency determiner 108) may utilize the average waiting time for PDCCH and PUSCH in a case of a PUSCH. For downlink link latency delay in a case HARQ feedback, the modem 106 (e.g., link latency determiner 108) may utilize the average waiting time for sending PUCCH feedback. For example, PUCCH delay may be utilized for downlink link latency delay, since the modem 106 may send feedback to a network (e.g., base station, eNB, gNB, etc.).

In some examples, the modem 106 (e.g., link latency determiner 108) calculates the TDD delay value as an average of slot delay values based on a TDD slot configuration of a TDD frame. For instance, the slot delay values may be uplink wait times for PUSCH, uplink wait times for PUCCH, or downlink wait times.

In some examples, the modem 106 (e.g., link latency determiner 108) determines the link latency based on a data transmission delay value. The data transmission delay value may be a duration of data transmission. For instance, the data transmission delay value may be a duration of a PUSCH (for uplink link latency, for example) or PDSCH (for downlink link latency, for example). In some examples, the data transmission delay value is 1 slot for uplink link latency. In some examples, the data transmission delay value is 11 symbols for downlink link latency (excluding DCI where the DCI and PDSCH are in the same slot, for instance).

In some examples, the modem 106 (e.g., link latency determiner 108) determines the data transmission delay value based on DCI. For example, the modem 106 (e.g., link latency determiner 108) calculates the data transmission delay value as an average transmission delay measured from DCI. In some examples, calculating an average transmission delay from DCI may provide a data transmission delay value with increased accuracy (relative to using set values, for example).

In some examples, the modem 106 (e.g., link latency determiner 108) determines the link latency based on a data processing delay value. The data processing delay value may be an amount of time to process data (e.g., PUSCH data or PDSCH data) at the network (e.g., RAN, base station, eNB, gNB, etc.) or the wireless communication device 102 (e.g., UE). For uplink link latency, for example, the data processing delay value is an amount of time for PUSCH decoding and/or L2 processing in the network (e.g., RAN, base station, eNB, gNB, etc.). In some examples, the data processing delay value for uplink link latency may be determined as a PDSCH processing (e.g., decoding) time and by adding a processing value (e.g., a value in 1-3 ms for L2 processing). For instance, the modem 106 (e.g., link latency determiner 108) determines the data processing delay value based on a numerology and/or a capability type. The modem 106 (e.g., link latency determiner 108) may look up the PDSCH processing time based on the numerology and/or capability type. For instance, the modem 106 may determine the PDSCH processing time in accordance with a PDSCH processing time table. A processing time (in a range of 1-3 ms, for instance) may be added to the PDSCH processing time to determine the data processing delay value. For uplink link latency, for example, the data processing delay value=PDSCH processing time+2 ms.

For downlink link latency, for example, the data processing delay value is an amount of time for PDSCH decoding and/or L2 processing in the wireless communication device 102 (e.g., UE, etc.). In some examples, the data processing delay value for downlink link latency may be determined as a PDSCH processing (e.g., decoding) time (e.g., N1 or time until HARQ feedback) and by adding values for grouping (e.g., 1 transmission time interval (TTI) or 1 slot) and/or other processing (e.g., a value in a range of 100-700 μs or another value for other modem processing). The grouping value may be time for grouping in an interface (e.g., 1 TTI for grouping). The value for other processing may be time for other modem processing (without radio link control (RLC) or packet data convergence protocol (PDCP) reassembly or reordering delay, for instance). For instance, the modem 106 (e.g., link latency determiner 108) determines the data processing delay value based on a numerology and a capability type. The modem 106 (e.g., link latency determiner 108) may look up the PDSCH processing time based on the numerology and capability type. For instance, the modem 106 may determine the PDSCH processing time in accordance with a PDSCH processing time table. Values for grouping and other processing (e.g., 1 slot and 500 μs or other values) may be added to the PDSCH processing time to determine the data processing delay value. For downlink link latency, for example, the data processing delay value=PDSCH processing time+1 slot+500 μs.

In some examples, the modem 106 (e.g., link latency determiner 108) determines (e.g., estimates) the network scheduling delay value based on wireless communication device 102 observation. After one or more SRs, for example, the modem 106 (e.g., link latency determiner 108) may measure a time until a next uplink grant. The modem 106 (e.g., link latency determiner 108) may determine an average network scheduling delay as an average of the measured times. In some examples, the modem 106 (e.g., link latency determiner 108) measures the time once per RRC connection, and may use that time as the network scheduling delay. Measuring the time(s) (and/or taking an average) may provide a network scheduling delay value with increased accuracy (relative to only looking up the PDSCH processing time and adding a scheduling delay quantity, for example).

Table (3) may be an example of a PDSCH processing time table. In Table (3), FR1 denotes frequency range 1, which may include sub-6 gigahertz (GHz) frequencies (in NR, for example). Frequency range 2 (FR2) is an example of another frequency range (for millimeter wave (mmWave), for instance).

TABLE (3)

| | | PDSCH Processing | PDSCH Processing |
|---|---|---|---|
| | | Time (N1) in | Time (N1) in |
| Numerology, μ | | Symbols for | Symbols for |
| (Subcarrier Spacing) | | Capability 1 | Capability 2 |
| 0 | (15 kilohertz (kHz)) | 13 | 3 |
| 1 | (30 kHz) | 13 | 4.5 |
| 2 | (60 kHz) | 20 | 9 (only if FR1, |
| | | | for example) |
| 3 | (120 kHz) | 24 | N/A |

In some examples, the modem 106 (e.g., link latency determiner 108) determines the link latency based on a HARQ delay value. The HARQ delay value may indicate delay due to HARQ retransmissions that increase link latency by the amount of time to retransmit a PUSCH or PDSCH.

In some examples, the modem 106 (e.g., link latency determiner 108) determines the HARQ delay value based on a number of HARQ retransmissions. For example, the modem 106 (e.g., link latency determiner 108) may multiply a HARQ delay value of a single HARQ retransmission by the number of the HARQ retransmissions to determine the HARQ delay value (for multiple HARQ retransmissions, for instance).

In some examples, the modem 106 (e.g., link latency determiner 108) determines link latency based on an SR failure delay value. An SR delay value may be a delay due to SR retransmissions that increase link latency by an amount of time to retransmit a SR. For instance, the SR failure delay value may be a scheduling request periodicity. For uplink link latency, for example, the SR failure delay=scheduling request periodicity.

In some examples, the modem 106 (e.g., link latency determiner 108) determines the SR failure delay value based on a number of SR failures and/or retransmissions. For example, the modem 106 (e.g., link latency determiner 108) may multiply a SR failure delay value of a single SR retransmission by the number of the SR retransmissions or failures to determine the SR failure delay value (for multiple SR retransmissions, for instance).

In some examples, the modem 106 (e.g., link latency determiner 108) may determine the link latency, where the link latency is an uplink link latency. The modem 106 (e.g., link latency determiner 108) may calculate the uplink link latency for an uplink without HARQ retransmission and/or SR failure as a sum of the inter modem-processor delay value, the wake-up time value, the SR delay value, the network scheduling delay value, the downlink control-to-data delay value, the TDD delay value (when TDD is configured, for instance), the data transmission delay value, and/or the data processing delay value. In some examples, one or more of the values are computed in time units and/or converted to time units (not slots and/or symbols, for instance) and then summed or added.

In some examples, the modem 106 (e.g., link latency determiner 108) may determine the uplink link latency with one HARQ retransmission and one SR retransmission. For instance, HARQ retransmission with a HARQ failure probability (e.g., a value in 5-25% or another value) and/or SR retransmission with an SR failure probability (e.g., a value in 5-25% or another value) may be factored into the uplink link latency determination.

In some examples, the modem 106 (e.g., link latency determiner 108) may estimate HARQ failure probability, SR failure probability, number of HARQ retransmissions, and/or number of SR retransmissions. For instance, the modem 106 (e.g., link latency determiner 108) determines and/or estimates HARQ failure probability, SR failure probability, number of HARQ retransmissions, and/or number of SR retransmissions based on one or more communications. The determined and/or estimated HARQ failure probability, SR failure probability, number of HARQ retransmissions, and/or number of SR retransmissions may be utilized in the uplink link latency determination. Determining and/or estimating the HARQ failure probability, SR failure probability, number of HARQ retransmissions, and/or number of SR retransmissions may provide a HARQ delay value and/or SR failure delay value with increased accuracy (relative to utilizing set values for HARQ failure probability, SR failure probability, number of HARQ retransmissions, and/or number of SR retransmissions, for example).

In some examples, the modem 106 (e.g., link latency determiner 108) determines the link latency based on at least one of a number of HARQ retransmissions or a HARQ failure probability. For instance, the modem 106 determines the HARQ delay value based on a number of retransmissions (which may factor into uplink and/or downlink link latency) and/or utilizes the HARQ failure probability in the link latency determination(s) as described herein.

In some examples, the modem 106 (e.g., link latency determiner 108) may determine the link latency, where the link latency is a downlink link latency. The modem 106 (e.g., link latency determiner 108) may calculate the downlink link latency for a downlink without HARQ retransmission as a sum of the inter modem-processor delay value, the network scheduling delay value, the downlink control-to-data delay value, the TDD delay value (when TDD is configured, for instance), the data transmission delay value, and/or the data processing delay value. In some examples, one or more of the values are computed in time units and/or converted to time units (not slots and/or symbols, for instance) and then summed or added.

In some examples, the modem 106 (e.g., link latency determiner 108) may determine the downlink link latency with one HARQ failure or retransmission. For instance, HARQ retransmission with a HARQ failure probability (e.g., a value in 5-25% or another value) may be factored into the downlink link latency determination.

In some examples, the modem 106 (e.g., link latency determiner 108) may estimate HARQ failure probability and/or number of HARQ retransmissions. For instance, the modem 106 (e.g., link latency determiner 108) determines and/or estimates HARQ failure probability and/or number of HARQ retransmissions based on one or more communications. The determined and/or estimated HARQ failure probability and/or number of HARQ retransmissions may be utilized in the downlink link latency determination. Determining and/or estimating the HARQ failure probability and/or number of HARQ retransmissions may provide a HARQ delay value with increased accuracy (relative to utilizing set values for HARQ failure probability and/or number of HARQ retransmissions, for example).

In some examples, the modem 106 (e.g., link latency determiner 108) is configured to determine a link latency based on a network scheduling delay value, downlink control-to-data delay value, data transmission delay value, and data processing delay value. The modem 106 (e.g., link latency determiner 108) may be configured to determine the link latency based on one or more of the other values described herein for determining an uplink link latency and/or a downlink link latency. The modem 106 may be configured to send the link latency to the processor 110. For example, the modem 106 may send the uplink link latency and/or the downlink link latency to the processor 110 over an interface (e.g., internal interface, bus, etc., between the modem 106 and the processor 110).

In some examples of the link latency estimation described herein, one or more link latencies may be estimated in one or more of the following conditions. The wireless communication device 102 (e.g., UE) may be in a connected mode. For instance, a transition delay from idle to connected mode may not be included in the link latency estimation in some examples. In some examples, the transition delay from idle to connected mode may be included in the link latency estimation. In some examples, link latency estimation may account for a default bearer and no quality of service (QoS) bearers (e.g., link latency estimation may ignore different SR configurations, semi-persistent scheduling (SPS) configuration, and/or logical channel prioritization (LCP) restrictions, etc., that are applicable for QoS bearers). In some examples, link latency estimation may account for QoS bearers based on use cases. In some examples, link latency estimation may be performed with sparse traffic (e.g., packets may be separated from each other by more than a few milliseconds, implying that the packets are scheduled independently (separate SR in uplink and/or no reliance on buffer status report (BSR)). In some examples, link estimation may be based on RRC configuration, without using other current communication value(s). In some examples, link estimation may be based on one or more current communication values (e.g., number of HARQ retransmissions, average data transmission delay from DCI, SSB monitoring occasion(s), K0 value from DCI, K2 value from DCI, measured scheduling delay, average scheduling delay, tracked sleep state, etc.). In some examples, the modem 106 (e.g., link latency determiner 108) may be configured to determine the link latency and/or send the link latency in a connected mode per RRC configuration (e.g., based on an RRC configuration and/or for each RRC configuration).

In some examples, the link latency estimation only includes RAN latency of the wireless communication device 102 and/or not far-end device (e.g., far-end UE, server, etc.) latency. In some examples, core network latency may not be included in the link latency estimation. For example, the modem 106 (e.g., link latency determiner 108) may determine the link latency without ping information. In some examples, the link latency may only indicate layer 1 (L1) and layer 2 (L2) delays. For instance, a difference between the link latency and end-to-end latency may correspond to the delays in the core network and/or far-end device. In some cases, the estimated link latency may be less than average end-to-end latency (e.g., ping latency). In some examples, the link latency estimation may be based on primary cell (PCell) and/or primary secondary cell (PSCell) configuration and support one numerology (e.g., only one numerology) across uplink and downlink BWPs. In some examples, link latency estimation may be performed with a cyclic prefix (e.g., normal cyclic prefix).

In some examples, the link latency is provided to the processor 110 (via a modem interface, for instance). One or more applications executed by the processor 110 may utilize the link latency. In some examples, the modem 106 and/or processor 110 is configured to determine whether to switch to one or more other links (e.g., Wi-Fi) based on the link latency. For instance, the processor 110 may compare the link latency to a threshold. If the link latency satisfies the threshold (e.g., is greater than the threshold), the processor 110 may switch to another link.

In some examples, the modem 106 and/or processor 110 is configured to determine whether to switch to a low-latency mode (LLM) based on the link latency. For example, the modem 106 and/or processor 110 may select the LLM if the link latency satisfies (e.g., is greater than) a threshold. In some examples, the processor 110 (e.g., an application executed by the processor 110) may check the link latency to determine whether the link latency is low enough for the demands of the application. For instance, some applications (e.g., gaming applications) may instruct the wireless communication device 102 (e.g., modem 106) to switch to low latency mode if the link latency is greater than a threshold.

In some examples, the modem 106 and/or processor 110 is configured to adjust a dejitter buffer based on the link latency. For example, in a voice over NR (VoNR) scenario, the modem 106 and/or processor 110 may utilize the link latency to adjust a dejitter buffer (which may reduce jitter for voice packets, for instance).

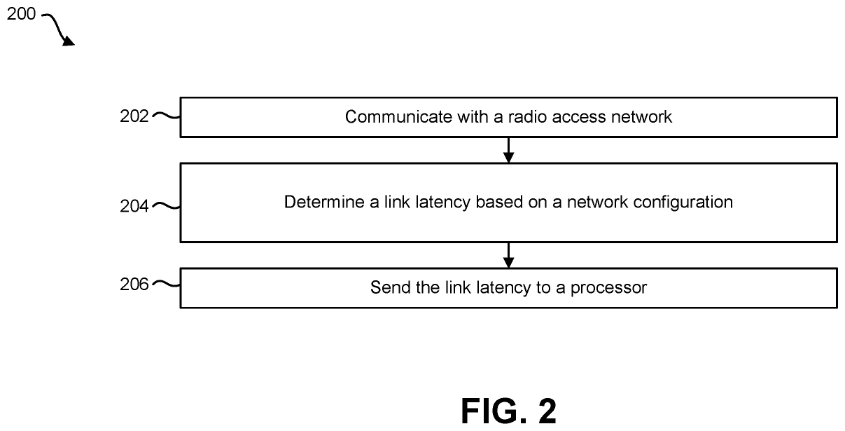

FIG. 2 is a flow diagram illustrating an example of a method 200 for link latency determination. In some examples, the method 200 is performed by a wireless communication device (e.g., the wireless communication device 102 described in relation to FIG. 1).

A wireless communication device may communicate 202 with a RAN (e.g., one or more base stations, eNBs, gNBs, etc.). For example, the wireless communication device communicates with the RAN to enter a connected mode. In some examples, an RRC configuration may be set up. For example, a base station (e.g., eNB, gNB, etc.) may send RRC configuration information to the wireless communication device.

The wireless communication device may determine 204 a link latency based on a network configuration. For instance, the wireless communication device may determine 204 the link latency (e.g., uplink link latency and/or downlink link latency) based on a network scheduling delay value, a downlink control-to-data delay value, a data transmission delay value, and/or a data processing delay value, etc. In some examples, determining 204 the link latency is performed as described in relation to FIG. 1. For example, the wireless communication device determines one or more factors or values and sums the factors or values to produce the link latency.

The wireless communication device may send 206 the link latency to a processor. In some examples, sending 206 the link latency is performed as described in relation to FIG. 1. For example, the wireless communication device sends the link latency to the processor over an interface (e.g., internal interface, modem interface, bus, etc.).

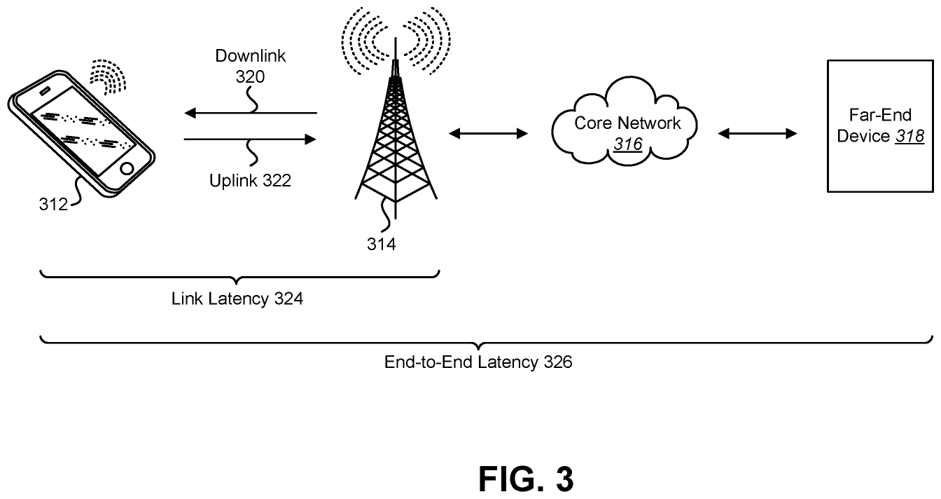

FIG. 3 is a diagram illustrating an example of a smartphone 312 in which examples of techniques for determining a link latency 324 may be implemented. The smartphone 312 may be an example of the wireless communication device 102 described in relation to FIG. 1. A base station 314 is also illustrated in FIG. 3. The base station 314 may be a RAN or may be included in a RAN. In this example, the smartphone 312 has established a wireless link with a base station 314. For instance, the smartphone 312 negotiates a link with the base station 314 and enters a connected mode. The smartphone 312 may receive traffic (e.g., payload data) from the base station 314 via a downlink 320 and/or may transmit traffic (e.g., payload data) to the base station 314 via an uplink 322.

The base station 314 communicates with a core network 316. The core network 316 includes one or more devices (e.g., routers, switches, servers, etc.) for communicating data (e.g., payload data) between the base station 314 and one or more devices (e.g., a far-end device 318). For example, the core network 316 transmits data (e.g., payload data) to a far-end device 318 and/or receives data (e.g., payload data) from the far-end device 318.

A link latency 324 may include a period (e.g., delay(s), time(s), etc.) for the smartphone 312 to communicate payload data to the base station 314 and/or for the base station 314 to communicate payload data to the smartphone 312. For example, the link latency 324 may include delays for scheduling a communication between the smartphone 312 and the base station 314, preparing (e.g., encoding, formatting, etc.) a communication by the smartphone 312 or base station 314, passing a communication between the smartphone 312 and the base station 314, and/or interpreting (e.g., decoding, de-formatting, etc.) a communication by the smartphone 312 or base station 314.

As illustrated in FIG. 3, the link latency 324 does not include delay(s) and/or time(s) associated with the core network 316 or the far-end device 318. An end-to-end latency 326 may include delay(s) and/or time(s) associated with the core network 316 and/or far-end device 318. In some approaches, an end-to-end latency 326 may be determined by sending a ping (e.g., ping packet) from the smartphone 312 to the far-end device 318, which may respond (e.g., echo) the ping to the smartphone 312. In some examples, the link latency 324 may be determined without the use of a ping (e.g., ping packet). For example, the smartphone 312 may not generate and/or send additional traffic (e.g., a ping, ping packet, etc.). The smartphone 312 may determine the link latency 324 based on uplink 322 parameters and/or downlink 320 parameters that are obtainable and/or observable without sending a ping. In some examples, the link latency 324 may include only delays attributable to layer 1 and/or layer 2 operations.

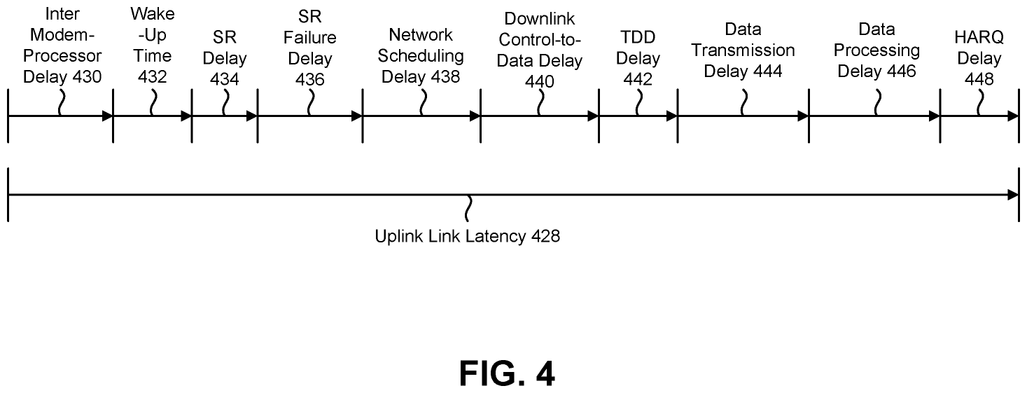

FIG. 4 is a diagram illustrating examples of delays and/or times that may occur in uplink link latency 428. Specifically, FIG. 4 illustrates an inter-modem processor delay 430, a wake-up time 432, an SR delay 434, an SR failure delay 436, a network scheduling delay 438, a downlink control-to-data delay 440, a TDD delay 442, a data transmission delay 444, a data processing delay 446, and a HARQ delay 448. The delays and/or times described in FIG. 4 may be represented by (e.g., quantified by) corresponding values (e.g., uplink values) described in relation to FIG. 1.

In an uplink, the inter modem-processor delay 430 may occur when a processor sends data (e.g., a packet) to a modem over an interface. The wake-up time 432 may occur when the modem transitions out of a sleep state. The SR delay 434 may occur when a wireless communication device (e.g., wireless communication device 102) generates and/or sends an SR to a base station. The SR failure delay 436 may occur when the base station does not respond to the SR, in which case the wireless communication device may repeat sending an SR to the base station. The network scheduling delay 438 may occur when the base station schedules an uplink communication. The downlink control-to-data delay 440 may occur when the base station sends DCI to the wireless communication device and before the corresponding payload data is sent from the wireless communication device. When TDD is configured, the TDD delay 442 may occur. The TDD delay 442 may occur due to a wait before an uplink slot that may carry the payload data. When TDD is not configured, the TDD delay 442 may not occur. The data transmission delay 444 may occur when the payload data is being transmitted from the wireless communication device to the base station. The data processing delay 446 may occur when the base station decodes the payload data. The HARQ delay 448 may occur if the payload data was unsuccessfully received at the base station and when a HARQ retransmission is scheduled and performed.

As described in relation to FIG. 1, the wireless communication device may determine and/or obtain values corresponding to one or more of the delays and/or times illustrated in FIG. 4. The corresponding values may be summed to estimate the uplink link latency 428. It should be noted that one or more of the illustrated delays may not occur or may be repeated in some approaches. Accordingly, one or more of the corresponding values described in relation to FIG. 1 may be omitted, set to 0, or multiplied in some approaches. In some examples, two or more of the values corresponding to the illustrated delays or times may be combined and/or expressed as a single value.

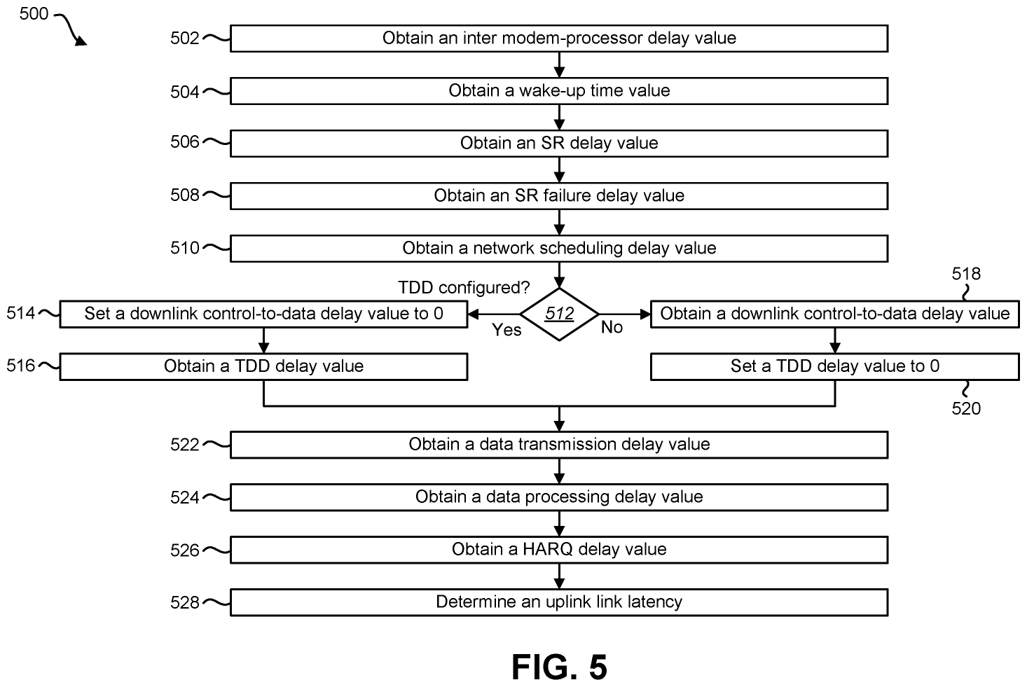

FIG. 5 is a flow diagram illustrating an example of a method 500 for determining an uplink link latency. In some examples, the method 500 is performed by a wireless communication device (e.g., the wireless communication device 102 described in relation to FIG. 1). In some examples, one or more of the functions, procedures, operations, etc., described in relation to FIG. 5 may be combined with one or more of the functions, procedures, operations, methods, etc. described herein.

A wireless communication device may obtain 502 an inter modem-processor delay value. In some examples, obtaining 502 the inter modem-processor delay value is performed as described in relation to FIG. 1. For example, the wireless communication device may read the inter modem-processor delay value (e.g., 1 ms) from memory and/or may add a waiting value to a static value to obtain 502 the inter modem-processor delay value.

The wireless communication device may obtain 504 a wake-up time value. In some examples, obtaining 504 the wake-up time value is performed as described in relation to FIG. 1. In some approaches, the wireless communication device may look up the wake-up time value based on a DRX cycle and whether an LLM is enabled (e.g., configured). For example, the wireless communication device (e.g., modem) may obtain (e.g., receive) the DRX cycle from configuration information from a network (e.g., base station, eNB, gNB, etc.). LLM configuration may be provided by a processor (e.g., as an application setting from an application processor). In some approaches, the wireless communication device may determine (e.g., calculate) the wake-up time value based on SSB occasions. For instance, the wireless communication device tracks sleep type and weights one or more values that are looked up based on the DRX cycle and whether the LLM is enabled.

The wireless communication device may obtain 506 an SR delay value. In some examples, obtaining 506 the SR delay value is performed as described in relation to FIG. 1. For example, the wireless communication device calculates the SR delay value by adding 1 symbol to the SR periodicity and dividing by 2. The wireless communication device may obtain (e.g., receive) the SR periodicity from a network (e.g., in configuration information via an RRC message from a base station).

The wireless communication device may obtain 508 an SR failure delay value. In some examples, obtaining 508 the SR failure delay value is performed as described in relation to FIG. 1. For example, the wireless communication device sets the SR failure delay value to an SR periodicity.

The wireless communication device may obtain 510 a network scheduling delay value. In some examples, obtaining 510 the network scheduling delay value is performed as described in relation to FIG. 1. For instance, the wireless communication device determines the network scheduling delay value by looking up a PDSCH processing time based on a numerology and a capability type and adding a scheduling delay quantity to the PDSCH processing time. The wireless communication device may obtain (e.g., receive) the numerology and/or capability type from a network (e.g., in configuration information via an RRC message from a base station). In some examples, the wireless communication device calculates the network scheduling delay by measuring a time between an SR and an uplink grant for multiple SRs and averaging the times. In some examples, the wireless communication device determines the network scheduling delay by measuring a time between an SR and an uplink grant for an RRC connection and using the time as the network scheduling delay.

The wireless communication device may determine 512 whether TDD is configured. For instance, the wireless communication device receives a signal (e.g., configuration message) from a base station indicating whether TDD is configured.

In a case that TDD is configured, the wireless communication device may set 514 a downlink control-to-data delay value to 0. The wireless communication device may obtain 516 a TDD delay value. In some examples, obtaining 516 a TDD delay value is performed as described in relation to FIG. 1. For instance, the wireless communication device determines slot delay values for the slots of a current TDD configuration and averages the slot delay values to determine the TDD delay value.

In a case that TDD is not configured (e.g., in a case that FDD is configured), the wireless communication device may obtain 518 a downlink control-to-data delay value. In some examples, obtaining 518 the downlink control-to-data delay value is performed as described in relation to FIG. 1. For example, the wireless communication device determines the downlink control-to-data delay value by looking up a PUSCH preparation time based on a numerology and a capability type and adding a DCI duration. In some examples, the wireless communication device determines the downlink control-to-data delay value by adding a DCI duration from network allocation to a K2 value from a DCI. The wireless communication device may set 520 a TDD delay value to 0.

The wireless communication device may obtain 522 a data transmission delay value. In some examples, obtaining 522 data transmission delay value is performed as described in relation to FIG. 1. For example, the wireless communication device reads the data transmission delay value for an uplink (e.g., 1 slot) from memory. In some examples, the wireless communication device calculates the data transmission delay value by averaging measured data transmission durations from DCI.

The wireless communication device may obtain 524 a data processing delay value. In some examples, obtaining 524 the data processing delay value is performed as described in relation to FIG. 1. For example, the wireless communication device looks up a PDSCH processing time based on a numerology and capability type and adds a constant processing value (e.g., 2 ms).

The wireless communication device may obtain 526 a HARQ delay value. In some examples, obtaining 526 a HARQ delay value is performed as described in relation to FIG. 1. For example, the wireless communication device calculates the HARQ delay value as a sum of the network processing delay value (e.g., 2 ms, without a part for PUCCH processing), downlink control-to-data delay value, TDD delay (if TDD is configured, for instance), data transmission delay value, data processing delay value (e.g., only the PDSCH processing time without the constant processing value for L2 processing).

The wireless communication device may determine 528 an uplink link latency. In some examples, determining 528 the uplink link latency is performed as described in relation to FIG. 1. For example, the wireless communication device sums one or more of the values to determine the uplink link latency.

In some examples, the uplink link latency may be provided to a processor and/or utilized to perform one or more operations. For example, the uplink link latency may be utilized to determine whether to switch links, enter an LLM, and/or adjust a dejitter buffer.

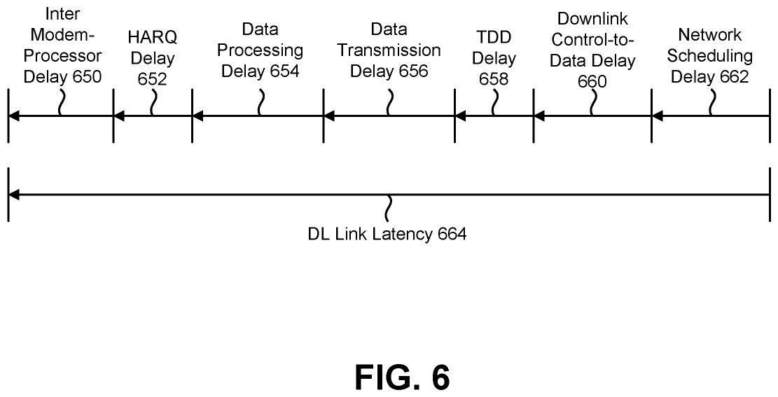

FIG. 6 is a diagram illustrating examples of delays and/or times that may occur in downlink link latency 664. Specifically, FIG. 6 illustrates a network scheduling delay 662, a downlink control-to-data delay 660, a TDD delay 658, a data transmission delay 656, a data processing delay 654, a HARQ delay 652, and an inter-modem processor delay 650. The delays and/or times described in FIG. 6 may be represented by (e.g., quantified by) corresponding values (e.g., downlink values) described in relation to FIG. 1.

In a downlink, the network scheduling delay 662 may occur when the base station schedules a downlink communication. The downlink control-to-data delay 660 may occur when the base station sends DCI to the wireless communication device and before the corresponding payload data is sent to the wireless communication device. When TDD is configured, the TDD delay 658 may occur. The TDD delay 658 may occur due to a wait before a downlink slot that may carry the payload data. When TDD is not configured, the TDD delay 658 may not occur. The data transmission delay 656 may occur when the payload data is being transmitted to the wireless communication device from the base station. The data processing delay 654 may occur when the wireless communication device decodes the payload data. The HARQ delay 652 may occur if the payload data was unsuccessfully received at the wireless communication device and when a HARQ retransmission is scheduled and performed. The inter modem-processor delay 650 may occur when a modem sends data (e.g., a packet) to a processor over an interface.

As described in relation to FIG. 1, the wireless communication device may determine and/or obtain values corresponding to one or more of the delays and/or times illustrated in FIG. 6. The corresponding values may be summed to estimate the downlink link latency 664. It should be noted that one or more of the illustrated delays may not occur or may be repeated in some approaches. Accordingly, one or more of the corresponding values described in relation to FIG. 1 may be omitted, set to 0, or multiplied in some approaches. In some examples, two or more of the values corresponding to the illustrated delays or times may be combined and/or expressed as a single value.

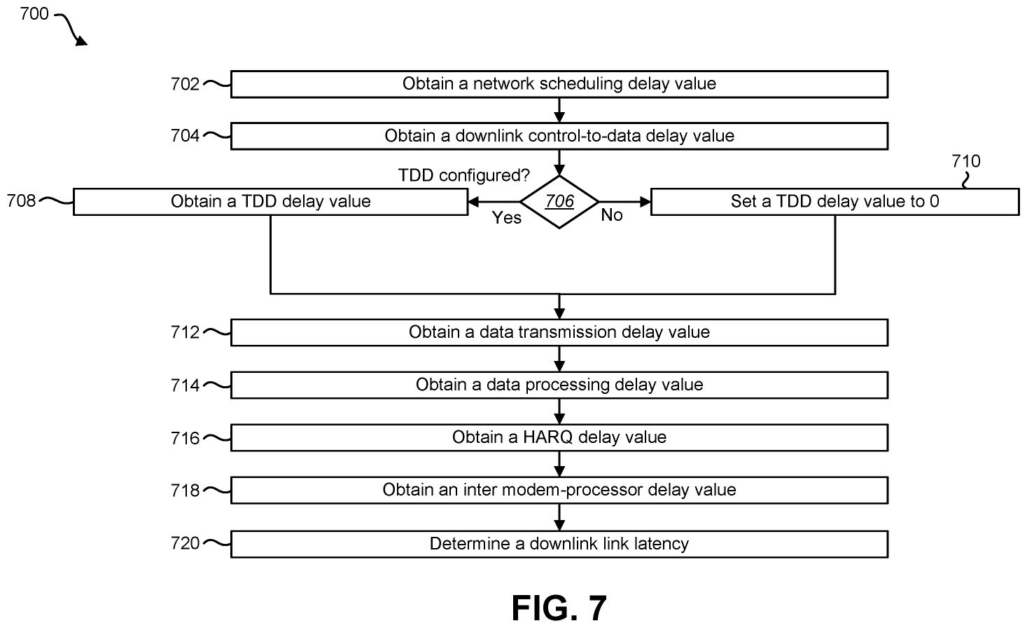

FIG. 7 is a flow diagram illustrating an example of a method 700 for determining a downlink link latency. In some examples, the method 700 is performed by a wireless communication device (e.g., the wireless communication device 102 described in relation to FIG. 1). In some examples, one or more of the functions, procedures, operations, etc., described in relation to FIG. 7 may be combined with one or more of the functions, procedures, operations, methods, etc. described herein.

A wireless communication device may obtain 702 a network scheduling delay value. In some examples, obtaining 702 the network scheduling delay value is performed as described in relation to FIG. 1. For instance, the wireless communication device determines the network scheduling delay value by reading a value (e.g., 4 ms) from memory.

The wireless communication device may obtain 704 a downlink control-to-data delay value. In some examples, obtaining 704 the downlink control-to-data delay value is performed as described in relation to FIG. 1. For example, the wireless communication device determines the downlink control-to-data delay value by reading a DCI duration (e.g., 3 symbols) from memory. In some examples, the wireless communication device determines the downlink control-to-data delay value by adding a DCI duration from network allocation to a K0 value from a DCI.

The wireless communication device may determine 706 whether TDD is configured. For instance, the wireless communication device receives a signal (e.g., configuration message) from a base station indicating whether TDD is configured.

In a case that TDD is configured, the wireless communication device may obtain 708 a TDD delay value. In some examples, obtaining 708 a TDD delay value is performed as described in relation to FIG. 1. For instance, the wireless communication device determines slot delay values for the slots of a current TDD configuration and averages the slot delay values to determine the TDD delay value. In a case that TDD is not configured, the wireless communication device may set 710 a TDD delay value to 0.

The wireless communication device may obtain 712 a data transmission delay value. In some examples, obtaining 712 data transmission delay value is performed as described in relation to FIG. 1. For example, the wireless communication device reads the data transmission delay value for a downlink (e.g., 11 symbols) from memory. In some examples, the wireless communication device calculates the data transmission delay value by averaging measured data transmission durations from DCI.

The wireless communication device may obtain 714 a data processing delay value. In some examples, obtaining 714 the data processing delay value is performed as described in relation to FIG. 1. For example, the wireless communication device looks up a PDSCH processing time based on a numerology and capability type and adds a grouping value (e.g., 1 slot) and a processing value (e.g., 500 μs).

The wireless communication device may obtain 716 a HARQ delay value. In some examples, obtaining 716 a HARQ delay value is performed as described in relation to FIG. 1. For example, the wireless communication device calculates the HARQ delay value as a sum of the (uplink) TDD delay for PUCCH (if TDD is configured, for instance), uplink network scheduling delay (which may be similar to a delay for PUCCH decoding and scheduling), downlink control-to-data delay value, (downlink) TDD delay value, data transmission delay value, and data processing delay value (e.g., only the PDSCH processing time).

A wireless communication device may obtain 718 an inter modem-processor delay value. In some examples, obtaining 718 the inter modem-processor delay value is performed as described in relation to FIG. 1. For example, the wireless communication device may read the inter modem-processor delay value (e.g., 1 ms) from memory and/or may add a waiting value to a static value to obtain 718 the inter modem-processor delay value.

The wireless communication device may determine 720 a downlink link latency. In some examples, determining 720 the downlink link latency is performed as described in relation to FIG. 1. For example, the wireless communication device sums one or more of the values to determine the downlink link latency.

In some examples, the downlink link latency may be provided to a processor and/or utilized to perform one or more operations. For example, the downlink link latency may be utilized to determine whether to switch links, enter an LLM, and/or adjust a dejitter buffer.

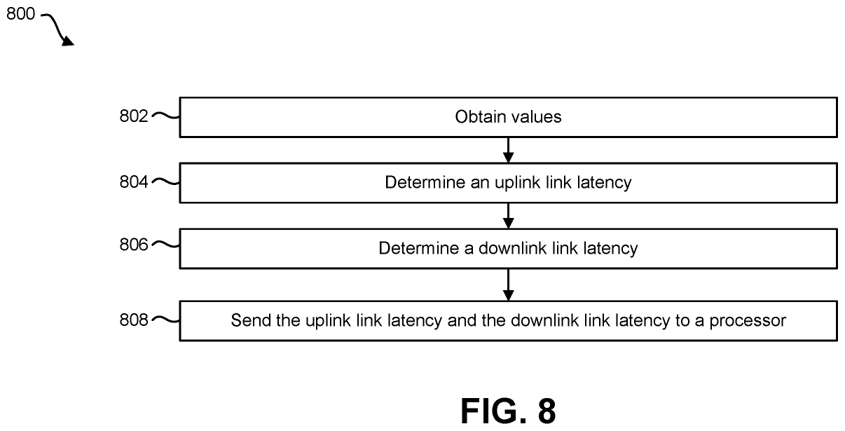

FIG. 8 is a flow diagram illustrating an example of a method 800 for determining an uplink link latency and a downlink link latency. In some examples, the method 800 is performed by a wireless communication device (e.g., the wireless communication device 102 described in relation to FIG. 1). In some examples, one or more of the functions, procedures, operations, etc., described in relation to FIG. 8 may be combined with one or more of the functions, procedures, operations, methods, etc. described herein.

A wireless communication device may obtain 802 values. In some examples, obtaining 802 the values is performed as described in relation to one or more of FIGS. 1-2, and 4-7. For instance, the wireless communication device determines one or more of the values described in relation to one or more of FIGS. 1-2 and 4-7.

The wireless communication device may determine 804 an uplink link latency. In some examples, determining 804 the uplink link latency is performed as described in relation to one or more of FIGS. 1-2 and 4-5.

The wireless communication device may determine 806 a downlink link latency. In some examples, determining 806 the downlink link latency is performed as described in relation to one or more of FIGS. 1-2 and 6-7.

The wireless communication device may send 808 the uplink link latency and the downlink link latency to a processor. In some examples, sending 808 the link latency is performed as described in relation to one or more of FIGS. 1-2. For example, the wireless communication device sends the uplink link latency and the downlink link latency to the processor over an interface (e.g., internal interface, modem interface, bus, etc.).

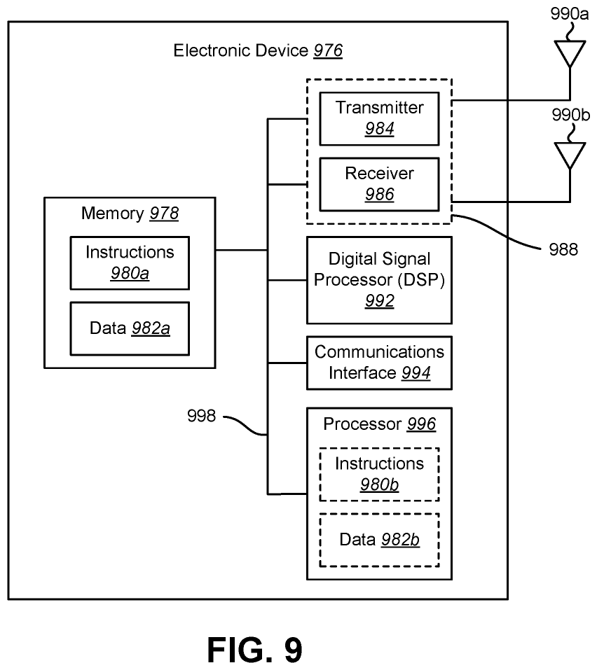

FIG. 9 illustrates certain components that may be included within an electronic device 976 configured to implement various examples of the systems and methods disclosed herein for link latency determination. The electronic device 976 may be an access terminal, a mobile station, a user equipment (UE), a smartphone, a digital camera, a video camera, a tablet device, a laptop computer, a desktop computer, an Internet of Things (IoT) device, a base station, an access point, a vehicle, a drone, etc. The electronic device 976 may be implemented in accordance with one or more of the wireless communication devices (e.g., wireless communication device 102) described herein.

The electronic device 976 includes a processor 996. The processor 996 may be a general purpose single- or multi-chip microprocessor (e.g., an ARM), a special purpose microprocessor (e.g., a digital signal processor (DSP)), a microcontroller, a programmable gate array, etc. The processor 996 may be referred to as a central processing unit (CPU) and/or a modem processor. Although a single processor 996 is shown in the electronic device 976, in an alternative configuration, a combination of processors (e.g., an ARM and DSP) could be implemented.

The electronic device 976 also includes memory 978. The memory 978 may be any electronic component capable of storing electronic information. The memory 978 may be embodied as random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), synchronous dynamic random-access memory (SDRAM), registers, and so forth, including combinations thereof.

Data 982a and instructions 980a may be stored in the memory 978. The instructions 980a may be executable by the processor 996 to implement one or more of the methods described herein. Executing the instructions 980a may involve the use of the data 982a that is stored in the memory 978. When the processor 996 executes the instructions 980, various portions of the instructions 980b may be loaded onto the processor 996 and/or various pieces of data 982b may be loaded onto the processor 996. In some examples, the instructions 980 may be executable to implement and/or perform one or more of the methods 200, 500, 700, 800, and/or one or more of the functions, procedures, and/or operations described herein.

The electronic device 976 may also include a transmitter 984 and a receiver 986 to allow transmission and reception of signals to and from the electronic device 976. The transmitter 984 and receiver 986 may be collectively referred to as a transceiver 988. One or more antennas 990a-b may be electrically coupled to the transceiver 988. The electronic device 976 may also include (not shown) multiple transmitters, multiple receivers, multiple transceivers, and/or additional antennas.

The electronic device 976 may include a digital signal processor (DSP) 992. The electronic device 976 may also include a communications interface 994. The communications interface 994 may allow and/or enable one or more kinds of input and/or output. For example, the communications interface 994 may include one or more ports and/or communication devices for linking other devices to the electronic device 976. In some examples, the communications interface 994 may include the transmitter 984, the receiver 986, or both (e.g., the transceiver 988). Additionally or alternatively, the communications interface 994 may include one or more other interfaces (e.g., touchscreen, keypad, keyboard, microphone, camera, etc.). For example, the communication interface 994 may enable a user to interact with the electronic device 976.

The various components of the electronic device 976 may be coupled together by one or more buses, which may include a power bus, a control signal bus, a status signal bus, a data bus, etc. For the sake of clarity, the various buses are illustrated in FIG. 9 as a bus system 998.

Some examples of the techniques described herein may be implemented and/or utilized in different scenarios. For example, some of the techniques may be implemented and/or utilized in one or more NR scenarios. Some of the techniques described herein may be implemented and/or performed in accordance with one or more of the following scenarios. For example, one or more of the devices (e.g., wireless communication device 102, electronic device 976), methods (e.g., method(s) 200, 500, 700, 800), operations, functions, techniques, etc., described herein may be implemented and/or performed in accordance with one or more of the following scenarios.

In some scenarios, if a link is an LTE stand-alone link, no link latency estimate may be determined and/or provided. In some scenarios, a link latency estimate may be determined and/or provided for an LTE stand-alone link. In some scenarios, if a link is an NR stand-alone link, the link latency may be estimated based on an NR configuration and/or numerology.

In some examples for Evolved Universal Mobile Telecommunication Service (UMTS) Terrestrial Radio Access Network (E-UTRAN) New Radio-Dual Connectivity (EN-DC) uplink, if a default bearer is a secondary cell group (SCG) bearer, or a split bearer with primary path SCG and a threshold is satisfied (e.g., threshold >0), the link latency may be estimated based on an NR configuration and/or numerology. For example, the threshold is checked to ensure that sparse traffic is actually occurring on NR. For instance, the threshold may be an uplink data split threshold that is utilized in a split bearer scenario to determine which bearer is utilized to send data (e.g., traffic). For instance, if the threshold is not satisfied, data is sent on one bearer. If the threshold is satisfied (e.g., threshold >0), then data (e.g., traffic) is sent on either or both bearers. Otherwise, no link latency estimate may be produced in some scenarios.

In some scenarios for EN-DC downlink, if a default bearer is an SCG bearer or a split bearer, the link latency is estimated based on an NR configuration and/or numerology. Otherwise, no link latency estimate may be produced in some scenarios.

In some scenarios for NR and NR dual connectivity (NR DC) with mixed numerology, for uplink, if a default bearer is a master cell group (MCG) bearer or a split bearer with primary path MCG, the link latency is estimated based on an NR MCG configuration and/or numerology. In some scenarios, if the default bearer is an SCG bearer or split bearer with primary path SCG, the link latency may be estimated based on NR SCG configuration and/or numerology.

In some scenarios for NR and NR DC with mixed numerology, for downlink, if a default bearer is an MCG bearer or a split bearer, the link latency is estimated based on an NR MCG configuration and/or numerology. In some scenarios, if the default bearer is an SCG bearer, the link latency may be estimated based on an NR SCG configuration and/or numerology.

In some scenarios for dual connectivity, a link latency is determined and/or sent (e.g., reported) for one or more cell groups. For instance, a first link latency is determined and/or sent (e.g., reported) for an MCG and a second link latency may be determined and/or sent for an SCG. For example, the modem 106 (e.g., link latency determiner 108) described in relation to FIG. 1 may determine and/or send a link latency (e.g., uplink link latency and/or downlink link latency) for one or more cell groups (e.g., based on each RRC configuration corresponding to each cell group).

In some scenarios for split bearer, a link latency is determined and/or sent (e.g., reported) based on the split bearer configuration. For instance, one link latency (e.g., one uplink link latency and/or one downlink link latency) is determined and/or sent (e.g., reported) for a split bearer configuration in some approaches. For example, the modem 106 (e.g., link latency determiner 108) described in relation to FIG. 1 may determine and/or send a link latency (e.g., only one uplink link latency and/or only one downlink link latency) for a split bearer configuration. In some examples, link latency determination for one or more split bearer scenarios may be performed as described herein.

In some scenarios with mixed numerology, a link latency is determined and/or sent (e.g., reported) based on the numerologies. For instance, a link latency (e.g., uplink link latency and/or downlink link latency) may be determined and/or sent (e.g., reported) for each numerology and/or cell. For example, the modem 106 (e.g., link latency determiner 108) described in relation to FIG. 1 may determine and/or send a link latency (e.g., uplink link latency and/or downlink link latency) for a first numerology (e.g., first cell and/or cell group) and may determine and/or send a second link latency (e.g., second uplink link latency and/or second downlink link latency) for a second numerology (e.g., second cell and/or cell group). In some examples, link latency determination for mixed numerology scenarios may be performed as described herein.

In some scenarios for NR carrier aggregation (CA) with mixed numerology, the link latency is estimated based on an NR primary cell (PCell) configuration and/or numerology. In some scenarios in idle mode, the link latency is estimated based on a previous RRC Connection configuration. In some scenarios where an Internet packet data network (PDN) is not present or the wireless communication device (e.g., UE) has moved to 3G/2G, no link latency estimate may be determined and/or provided.

In some approaches, one or more link latency estimates are reported in accordance with one or more of the following examples. In some examples, lower layers report the link latency estimate when (e.g., each time) an RRC configuration is received and/or when LLM is enabled. In some examples, the reported link latency (e.g., number) from lower layers may be an overall uplink link latency and/or an overall downlink link latency. In some examples, the modem reports the link latency estimate(s) to one or more applications via an interface between a modem and processor. In some examples, the reported numbers may include overall uplink link latency (which may include uplink inter modem-processor delay, for instance) and/or overall downlink link latency (which may include downlink inter modem-processor delay, for instance). In some examples, link latency (e.g., uplink link latency and/or downlink link latency) is reported in units of time (e.g., milliseconds with an accuracy of 3 decimal places). In some examples, there may be no reporting in idle mode, but a previous estimate based on a previous RRC connection may be utilized for an application until a next RRC connection.

Listing (1), Listing (2), and Listing (3) provide examples of RRC configuration details. In some examples, one or more of the values described in Listing (1), Listing (2), and/or Listing (3) may be utilized to estimate a link latency.

Listing (1) illustrates an example of CDRX configuration. In some examples, the DRX cycle may be utilized to determine a wake-up time value as described herein. For instance, the drx-LongCycleStartOffset in Listing (1) may be utilized to determine a wake-up time value.

| | |
|---|---|
| DRX-Config ::= | SEQUENCE { |

| | |
|---|---|
| drx-onDurationTimer | CHOICE { |

subMilliSeconds INTEGER (1..31),
milliseconds ENUMERATED {

ms1, ms2, ms3, ms4, ms5, ms6, ms8, ms10, ms20, ms30,

ms40, ms50, ms60,

ms80, ms100, ms200, ms300, ms400, ms500, ms600,

ms800, ms 1000, ms 1200,

ms1600, spare8, spare7, spare6, spare5, spare4, spare3,

spare2, spare1 }

},

| | |
|---|---|
| drx-InactivityTimer | ENUMERATED { |

ms0, ms1, ms2, ms3, ms4, ms5, ms6, ms8, ms10, ms20, ms30,

ms40, ms50, ms60, ms80,

ms100, ms200, ms300, ms500, ms750, ms1280, ms1920,

ms2560, spare9, spare8,

spare7, spare6, spare5, spare4, spare3, spare2, spare1 },

| | |
|---|---|
| drx-HARQ-RTT-TimerDL | INTEGER (0..56), |
| drx-HARQ-RTT-TimerUL | INTEGER (0..56), |
| drx-RetransmissionTimerDL | ENUMERATED { |

sl0, sl1, sl2, sl4, sl6, sl8, sl16, sl24, sl33, sl40, sl64, sl80, sl96,

sl112, sl128,

sl160, sl320, spare15, spare14, spare13, spare12, spare11,

spare10, spare9,

spare8, spare7, spare6, spare5, spare4, spare3, spare2,

spare1 },

| | |
|---|---|
| drx-RetransmissionTimerUL | ENUMERATED { |

sl0, sl1, sl2, sl4, sl6, sl8, sl16, sl24, sl33, sl40, sl64, sl80, sl96,

sl112, sl128,

sl160, sl320, spare15, spare14, spare13, spare12, spare11,

spare10, spare9,

spare8, spare7, spare6, spare5, spare4, spare3, spare2, spare1

},

| | |
|---|---|
| drx-LongCycleStartOffset | CHOICE { |

| | |
|---|---|
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0..2047), |
| ms2560 | INTEGER(0..2559), |
| ms5120 | INTEGER(0..5119), |
| ms10240 | INTEGER(0..10239) |

| }, | |
|---|---|
| shortDRX | SEQUENCE { |

| | |
|---|---|
| drx-ShortCycle | ENUMERATED { |

ms2, ms3, ms4, ms5, ms6, ms7, ms8, ms10, ms14, ms16,

ms20, ms30, ms32,

ms35, ms40, ms64, ms80, ms128, ms160, ms256, ms320,

ms512, ms640, spare9,

spare8, spare7, spare6, spare5, spare4, spare3, spare2,

spare1 },

| | |
|---|---|
| drx-ShortCycleTimer | INTEGER (1..16) |

}

OPTIONAL, -- NeedR

| | |
|---|---|
| drx-SlotOffset | INTEGER (0..31) |

}

Listing (1)

Listing (2) illustrates an example of SR configuration. In some examples, the SR periodicity may be utilized to determine an SR delay value as described herein. For instance, the periodicityAndOffset in Listing (2) may be utilized to determine an SR delay value.

SchedulingRequestResourceConfig ::= SEQUENCE {

| | |
|---|---|
| schedulingRequestResourceId | , |

| | |
|---|---|
| schedulingRequestID | , |
| periodicityAndOffset | CHOICE { |

| | |
|---|---|
| sym2 | NULL, |
| sym6or7 | NULL, |

| | | |
|---|---|---|
| sl1 | NULL, | -- Recurs in every slot |

| | |
|---|---|
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |

| | |
|---|---|
| sl160 | INTEGER (0..159), |
| sl320 | INTEGER (0..319), |
| sl640 | INTEGER (0..639) |

}

OPTIONAL, -- Need M

| | |
|---|---|
| resource | PUCCH-ResourceId |

OPTIONAL -- Need M
}

Listing (2)

Listing (3) illustrates an example of TDD configuration. In some examples, the TDD slot configuration may be utilized to determine a TTD delay value as described herein. For instance, the TDD-UL-DL-Pattern in Listing (3) may be utilized to determine a TDD delay value.

| | |
|---|---|
| TDD-UL-DL-ConfigCommon ::= | SEQUENCE { |

| | |
|---|---|
| referenceSubcarrierSpacing | SubcarrierSpacing, |
| pattern1 | TDD-UL-DL-Pattern, |
| pattem2 | TDD-UL-DL-Pattern |

OPTIONAL, -- Need R

...

}

| | |
|---|---|
| TDD-UL-DL-Pattern ::= | SEQUENCE { |

| | |
|---|---|
| dl-UL-TransmissionPeriodicity | ENUMERATED {ms0p5, ms0p625, ms1, |

ms1p25, ms2, ms2p5, ms5, ms10},

| | |
|---|---|
| nrofDownlinkSlots | INTEGER (0..maxNrofSlots), |
| nrofDownlinkSymbols | INTEGER (0..maxNrofSymbols−1), |
| nrofUplinkSlots | INTEGER (0..maxNrofSlots), |
| nrofUplinkSymbols | INTEGER (0..maxNrofSymbols−1), |

...,
[[
dl-UL-TransmissionPeriodicity-v1530 ENUMERATED {ms3, ms4}

OPTIONAL -- Need R

]]

}

| | |
|---|---|
| TDD-UL-DL-ConfigDedicated ::= | SEQUENCE { |

slotSpecificConfigurationsToAddModList SEQUENCE (SIZE (1..maxNrofSlots))

| | |
|---|---|
| OF TDD-UL-DL-SlotConfig | OPTIONAL, -- Need N |

slotSpecificConfigurationsToreleaseList SEQUENCE (SIZE (1..maxNrofSlots))

| | |
|---|---|
| OF TDD-UL-DL-SlotIndex | OPTIONAL,-- Need N |

...

}

| | |
|---|---|
| TDD-UL-DL-SlotConfig ::= | SEQUENCE{ |

| | |
|---|---|
| slotIndex | TDD-UL-DL-SlotIndex, |
| symbols | CHOICE { |

| | |
|---|---|
| allDownlink | NULL, |
| allUplink | NULL, |
| explicit | SEQUENCE { |

| | |
|---|---|
| nrofDownlinkSymbols | INTEGER (1..maxNrofSymbols−1) |

OPTIONAL, -- Need S

| | |
|---|---|
| nrofUplinkSymbols | INTEGER (1..maxNrofSymbols−1) |

OPTIONAL -- Need S

}

}

}

| | |
|---|---|
| TDD-UL-DL-SlotIndex ::= | INTEGER (0..maxNrofSlots−1) |

Listing (3)

The term “determining” encompasses a wide variety of actions and, therefore, “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” may describe “based only on” and/or “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example and not limitation, a computer-readable medium may comprise RAM, ROM, EEPROM, compact disc read-only memory (CD-ROM) or other optical disk storage, magnetic disk storage or other magnetic storage devices, or any other medium that can be used to carry or store program code in the form of instructions and/or data structures and that can be accessed by a computer. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. A computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, can be downloaded, and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

As used herein, the term “and/or” may mean one or more items. For example, the phrase “A, B, and/or C” may mean any of: only A, only B, only C, A and B (but not C), B and C (but not A), A and C (but not B), or all of A, B, and C. As used herein, the phrase “at least one of” may mean one or more items. For example, the phrase “at least one of A, B, and C” or the phrase “at least one of A, B, or C” may mean any of: only A, only B, only C, A and B (but not C), B and C (but not A), A and C (but not B), or all of A, B, and C. As used herein, the phrase “one or more of” may mean one or more items. For example, the phrase “one or more of A, B, and C” or the phrase “one or more of A, B, or C” may mean any of: only A, only B, only C, A and B (but not C), B and C (but not A), A and C (but not B), or all of A, B, and C.

It is to be understood that the claims are not limited to the precise configuration and components illustrated above. Various modifications, changes, and variations may be made in the arrangement, operation, and details of the systems, methods, and apparatus described herein without departing from the scope of the claims. For example, one or more of the operations, functions, elements, aspects, etc., described herein may be omitted or combined.

Some examples of the systems, methods, and/or techniques described herein are given as follows. In a first example, a method includes determining, by a modem, a link latency based on a network configuration; and sending, by the modem, the link latency to a processor. In a second example in combination with the first example, the method includes determining, by the modem, the link latency based on an inter modem-processor delay value.

In a third example in combination with any of the preceding examples, the method includes determining, by the modem, the link latency based on a time-division duplexing (TDD) delay value in a case that TDD is configured. In a fourth example in combination with the third example, the method includes calculating, by the modem, the TDD delay value as an average of slot delay values based on a TDD slot configuration.

In a fifth example in combination with any of the preceding examples, the method includes determining, by the modem, the link latency based on a hybrid automatic repeat request (HARQ) delay value. In a sixth example in combination with any of the preceding examples, the method includes determining, by the modem, the link latency based on a number of HARQ retransmissions or a HARQ failure probability.

In a seventh example in combination with any of the preceding examples, the method includes determining, by the modem, the link latency based on a data transmission delay value. In an eighth example in combination with the seventh example, the method includes determining, by the modem, the data transmission delay value based on downlink control information (DCI).

In a ninth example in combination with any of the preceding examples, the method includes determining, by the modem, the link latency based on a data processing delay value that is based on a numerology. In a tenth example in combination with any of the preceding examples, the method includes determining, by the modem, the link latency based on a data processing delay value that is based on a capability type.

In an eleventh example in combination with any of the preceding examples, the method includes determining, by the modem, the link latency based on a wake-up time value. In a twelfth example in combination with the eleventh example, the method includes determining, by the modem, the wake-up time value based on a discontinuous reception (DRX) cycle, whether a low latency mode (LLM) is enabled, or a synchronization signal block (SSB) monitoring occasion.

In a thirteenth example in combination with any of the preceding examples, the method includes determining, by the modem, the link latency based on a scheduling request (SR) delay value. In a fourteenth example in combination with the thirteenth example, the method includes determining, by the modem, the SR delay value based on a SR periodicity.

In a fifteenth example in combination with any of the preceding examples, the method includes determining, by the modem, the link latency based on a scheduling request (SR) failure delay value.

In a sixteenth example in combination with any of the preceding examples, the method includes determining, by the modem, the link latency based on a network scheduling delay value. In a seventeenth example in combination with the sixteenth example, the method includes determining, by the modem, the network scheduling delay value based on a numerology and a capability type.

In an eighteenth example in combination with any of the preceding examples, the link latency is an uplink link latency. In a nineteenth example in combination with any of the first to tenth examples, the link latency is a downlink link latency.

In a twentieth example in combination with any of the preceding examples, the method includes determining, by the modem, the link latency based on a downlink control-to-data delay value. In a twenty-first example in combination with the twentieth example, the method includes determining, by the modem, the downlink control-to-data delay value based on a numerology, a capability type, and a duplexing type. In a twenty-second example in combination with the twentieth example, the method includes determining, by the modem, the downlink control-to-data delay value based on downlink control information (DCI).

In a twenty-third example in combination with any of the preceding examples, the method includes determining, by the processor, whether to switch to another link based on the link latency, determining whether to switch to a low latency mode (LLM) based on the link latency, or adjusting a dejitter buffer based on the link latency.

In a twenty-fourth example in combination with any of the preceding examples, the method includes, by the modem, determining the link latency and sending the link latency in a connected mode per radio resource control (RRC) configuration. In a twenty-fifth example in combination with any of the preceding examples, the method includes, by the modem, determining the link latency and sending the link latency for a master cell group (MCG) and includes, by the modem, determining a second link latency and sending the second link latency for a secondary cell group (SCG).

In a twenty-sixth example in combination with any of the preceding examples, the method includes, by the modem, determining the link latency and sending the link latency for a split bearer. In a twenty-seventh example in combination with any of the preceding examples, the method includes, by the modem, determining the link latency and sending the link latency for a first numerology and includes, by the modem, determining a second link latency and sending the second link latency for a second numerology.

In a twenty-eighth example in combination with any of the preceding examples, a wireless communication device includes a modem that is configured to perform any of the methods of any of the first to twenty-second examples and/or any of the twenty-fourth to twenty-seventh examples. In a twenty-ninth example in combination with any of the preceding examples, a wireless communication device includes a processor that is configured to perform the method of the twenty-third example.

In a thirtieth example in combination with any of the first to the twenty-seventh examples, a non-transitory tangible computer-readable medium stores computer-executable code that includes code for causing a modem and/or processor to perform any of the methods of any of the first to twenty-seventh examples. In a thirty-first example in combination with any of the first to the twenty-seventh examples, an apparatus includes means for performing any of the methods of any of the first to twenty-seventh examples.

In a thirty-second example in combination with any of the preceding examples, the link latency is determined without ping information. In a thirty-third example in combination with any of the preceding examples, the link latency indicates layer 1 and layer 2 delays.

What is claimed is:

1. A wireless communication device, comprising:
a modem, wherein the modem is configured to:
determine a link latency based on a network configuration; and
send the link latency to a processor.

2. The wireless communication device of claim 1, wherein the modem is configured to determine the link latency based on an inter modem-processor delay value.

3. The wireless communication device of claim 1, wherein the modem is configured to determine the link latency based on a time-division duplexing (TDD) delay value in a case that TDD is configured.

4. The wireless communication device of claim 3, wherein the modem is configured to calculate the TDD delay value as an average of slot delay values based on a TDD slot configuration.

5. The wireless communication device of claim 1, wherein the modem is configured to determine the link latency based on a hybrid automatic repeat request (HARQ) delay value.

6. The wireless communication device of claim 1, wherein the modem is configured to determine the link latency based on a number of HARQ retransmissions or a HARQ failure probability.

7. The wireless communication device of claim 1, wherein the modem is configured to determine the link latency based on a data transmission delay value.

8. The wireless communication device of claim 7, wherein the modem is configured to determine the data transmission delay value based on downlink control information (DCI).

9. The wireless communication device of claim 1, wherein the modem is configured to determine the link latency based on a data processing delay value that is based on a numerology.

10. The wireless communication device of claim 1, wherein the modem is configured to determine the link latency based on a data processing delay value that is based on a capability type.

11. The wireless communication device of claim 1, wherein the modem is configured to determine the link latency based on a wake-up time value.

12. The wireless communication device of claim 11, wherein the modem is configured to determine the wake-up time value based on a discontinuous reception (DRX) cycle, whether a low latency mode (LLM) is enabled, or a synchronization signal block (SSB) monitoring occasion.

13. The wireless communication device of claim 1, wherein the modem is configured to determine the link latency based on a scheduling request (SR) delay value.

14. The wireless communication device of claim 13, wherein the modem is configured to determine the SR delay value based on a SR periodicity.

15. The wireless communication device of claim 1, wherein the modem is configured to determine the link latency based on a scheduling request (SR) failure delay value.

16. The wireless communication device of claim 1, wherein the modem is configured to determine the link latency based on a network scheduling delay value.

17. The wireless communication device of claim 16, wherein the modem is configured to determine the network scheduling delay value based on a numerology and a capability type.

18. The wireless communication device of claim 1, wherein the link latency is an uplink link latency.

19. The wireless communication device of claim 1, wherein the link latency is a downlink link latency.

20. The wireless communication device of claim 1, wherein the modem is configured to determine the link latency based on a downlink control-to-data delay value.

21. The wireless communication device of claim 20, wherein the modem is configured to determine the downlink control-to-data delay value based on a numerology, a capability type, and a duplexing type.

22. The wireless communication device of claim 20, wherein the modem is configured to determine the downlink control-to-data delay value based on downlink control information (DCI).

23. The wireless communication device of claim 1, wherein the processor is configured to determine whether to switch to another link based on the link latency, is configured to determine whether to switch to a low latency mode (LLM) based on the link latency, or is configured to adjust a dejitter buffer based on the link latency.

24. The wireless communication device of claim 1, wherein the modem is configured to determine the link latency and send the link latency in a connected mode per radio resource control (RRC) configuration.

25. The wireless communication device of claim 1, wherein the modem is configured to determine the link latency and send the link latency for a master cell group (MCG) and is configured to determine a second link latency and send the second link latency for a secondary cell group (SCG).

26. The wireless communication device of claim 1, wherein the modem is configured to determine the link latency and send the link latency for a split bearer.

27. The wireless communication device of claim 1, wherein the modem is configured to determine the link latency and send the link latency for a first numerology and is configured to determine a second link latency and send the second link latency for a second numerology.

28. A method performed by a wireless communication device, comprising:
determining, by a modem, a link latency based on a network configuration; and
sending, by the modem, the link latency to a processor.

29. A non-transitory tangible computer-readable medium storing computer-executable code, comprising:
code for causing a modem to determine a link latency based on a network configuration; and
code for causing the modem to send the link latency to a processor.

30. An apparatus, comprising:
means for determining a link latency on a modem based on a network configuration; and
means for sending the link latency to a processor.
